(19) United States
(12) Patent Application Publication
(10) Pub. No.: US 2006/0080112 A1
(43) Pub. Date: Apr. 13, 2006

(54) Method and apparatus for ownership transfer of transactions in peer-to-peer systems

(76) Inventors: Wilhelmus Franciscus Johannes Fontijn, Eindhoven (NL); Alexandre Sinitsyn, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/548,248

(22) PCT Filed: Mar. 9, 2004
(86) PCT No.: PCT/IB04/50215

§ 371 Date: Sep. 6, 2005

(30) Foreign Application Priority Data
Mar. 10, 2003 (EP) 03100591.1

(51) Int. Cl. G06Q 99/00

(52) U.S. Cl. 705/1

(57) ABSTRACT

This invention relates to a method of, a device and a protocol for performing ownership transfer of a change in a peer to peer network (30). The device or a peer can be a car, a garage, a video cassette recorder (VCR), a personal digital assistant (PDA), a mobile phone, a climate system, a television, a lamp, a coffee machine, a radio, a DVD player, a CD player, an information panel, a web tablet, a smart remote, an answering machine, a personal computer. Said method includes the steps of attempting, by means of a first device (31) to find a second device (32) which will accept responsibility for committing said change; transferring, by means of said first device, responsibility of committing the change to said second device and propagating the change to said second device, wherein a global commit status variable is further transferred to said second device and where said global commit status variable is maintained on said second device; setting, by means of said first device, a local commit status variable to “provisional” signifying that the device will act as if the global commit went through, wherein said first device will wait with setting the local commit status variable to ‘void’, signifying a real commit, until it gets confirmation that the global commit status variable is set to ‘void’ also, when said first device re-enters said network and checks the status of the global commit status variable; or setting, by means of said first device, the local commit status variable to ‘void’ signifying a real commit; and propagating, by means of said second device, said change to one or more devices (33, 34) for which said change is relevant, when responsibility of committing the change is received and accepted on said second device.

This invention relates to a method of performing ownership transfer of a change in a peer to peer network.

The change is transferred among various devices in said peer to peer network.

The present invention also relates to a computer system for performing the method.

The present invention further relates to a computer program product for performing the method.

Additionally, the present invention relates to a protocol for ownership transfer of a change.

The present invention further relates to a device corresponding to a peer, which belongs to said peer to peer network.

The invention further relates to a computer program product comprising code means stored on a computer readable medium for performing such a method.

WO 02/39305 discloses information management via delegated control. An information management system utilizes delegated control over a dataset. Said information management system comprises more computers and more software applications interacting to store information. Said delegated control is a transfer, temporary or partially of said dataset from a delegating system (as a so called “delegator”) to a delegate system.

Committing transactions or delegating control in distributed databases is known to be difficult. In the art, currently there are three options for a basic transaction model:

Firstly, the originating part sends the update to a central transaction server and this server is responsible for updating all relevant parts and committing the change.

Secondly, the originating part propagates an update to all parts of the database that are relevant and commits the change as soon as it gets a message from all relevant parts that they received the update.

Thirdly, the commitment is not performed explicitly. There are protocols, e.g. so called “gossip protocols” that just propagate the change and assume a commit (see references below).

David Kempe, Jon M. Kleinberg, and Alan J. Demers. Spatial gossip and resource location protocols. In ACM Symposium on Theory of Computing, pages 163-172, 2001.

Alan Demers, Dan Greene, Carl Houser, Wes Irish, and John Larson. Epidemic algorithms for replicated database maintenance. SIGOPS, 22(1):8-32, 1987.

The first option of using the server is a problem since not all distributed database have a central server that controls all transactions, e.g. in P2P (peer to peer) systems. In which case, the first option is out of question.

In addition, some distributed databases have parts that are not always in contact with all relevant parts and/or the central transaction server, i.e. ad-hoc connections, in which case the second option is out of question. As a result, the originating part may not be able commit the change.

In many cases it is not an option not to commit explicitly because it means that there is no certainty about the commit. In this case the third option is out of question.

This leaves the problem of having no adequate reliable/robust transaction model in a peer to peer communication, i.e. it is a problem that a transaction of a change e.g. to a database, a file, etc.—where the database, the file, etc. resides on other peer(s) than that who wishes to have the change performed—in some occasions is not performed. As a consequence, said file, database, etc. is left un-updated—and what is even worse—the requester of said change is not aware of it.

From the art it is known that Peer-to-peer is a communications model in which each party (i.e. each peer) has the same capabilities and either party can initiate a communication session. Other models with which the Peer-to-peer communications model might be contrasted include the client/server model and the master/slave model, both also known in the art. In some cases, peer-to-peer communications is implemented by giving each communication node both server and client capabilities. In recent usage, peer-to-peer has come to describe applications in which users can use the Internet to exchange files, update databases with each other directly or through a mediating server.

On the Internet, peer-to-peer (referred to as P2P) is a type of transient Internet network that allows a group of computer users (peers) with the same networking program to connect with each other and directly access files from one another's hard drives. Napster and Gnutella are examples of this kind of peer-to-peer software. Corporations are looking at the advantages of using P2P as a way for employees to share files, update and access common databases, information, etc without the expense involved in maintaining a centralized server and as a way for businesses to exchange information with each other directly.

When the Internet P2P is applied, it is known in the art that the user must first download and execute a peer-to-peer networking program, e.g. Gnutella-net is currently one of the most popular of these decentralized P2P programs because it allows users to exchange all types of files. After launching the program, the user enters the IP address of another computer belonging to the network, typically, the Web page where the user obtained the download will list several IP addresses as places to begin. Once the computer finds another network member on-line, it will connect to that user's connection, which has obtained their IP address from a connection of another user, and so on.

It is further known in the art that users of peers can choose how many member connections to seek at one time and determine which files, databases, information items, etc they wish to share, update or password protect, but still said problems are left unsolved.

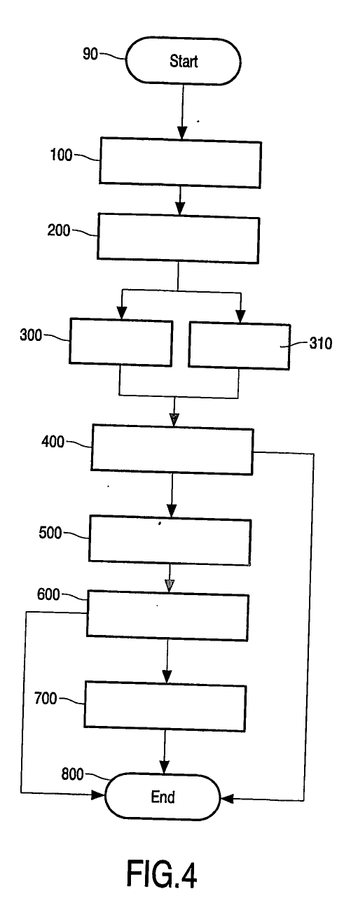

However, said problems are solved by said method of the present invention, when the method comprises the steps as discussed in FIG. 4.

It is hereby an advantage of the invention that a method and a protocol, respectively is proposed that enables the delegation of the responsibility to commit a change.

The invention further has the advantage that commitment of a change can be effectuated even if the initiator (first device as claimed) of the change is no longer connected.

In most cases the integrity of the distributed database can be maintained and guaranteed. Further, by not having a central server makes peer to peer network less vulnerable and further enables for any high number of peers communicating, i.e. the network can be scaled up and down and still has said advantages.

Said system, protocol and device, respectively provides the same advantages and solves the same problem(s) for the same reasons as described previously in relation to the method.

The invention will be explained more fully below in connection with preferred embodiments and with reference to the drawings, in which:

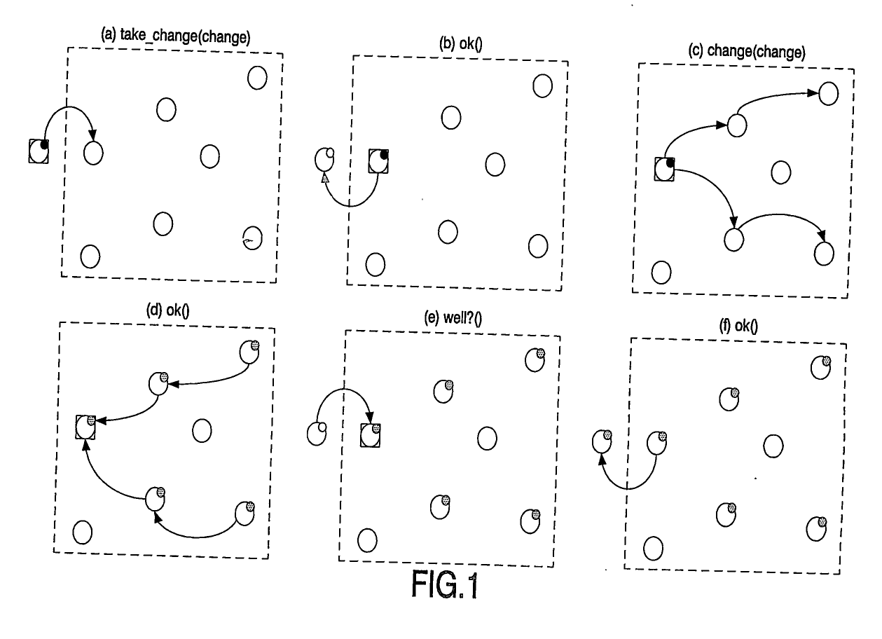

FIG. 1 shows various ways for a peer in contact with the system transferring responsibility for an update to a peer in constant contact with the system;

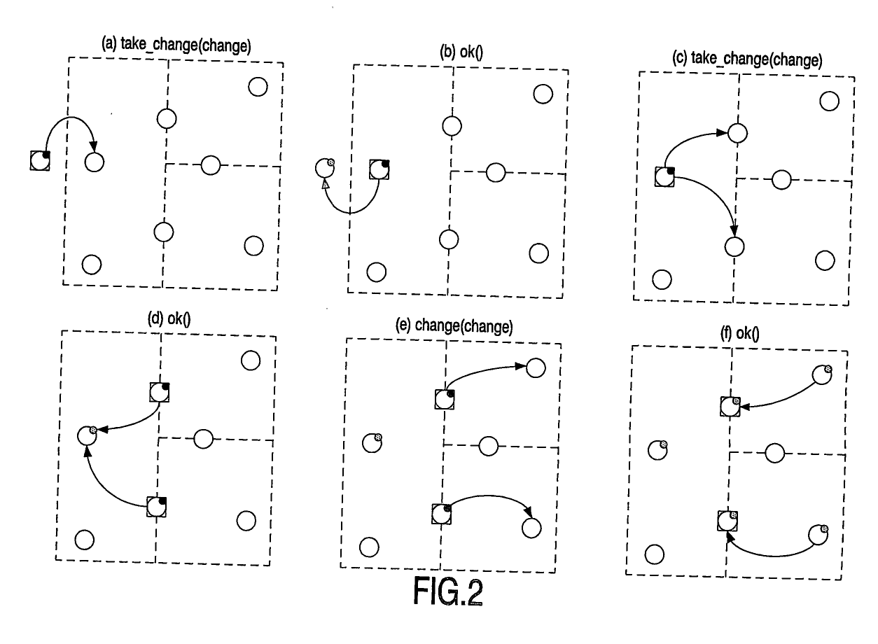

FIG. 2 shows responsibility transfer with status change on a commit status variable;

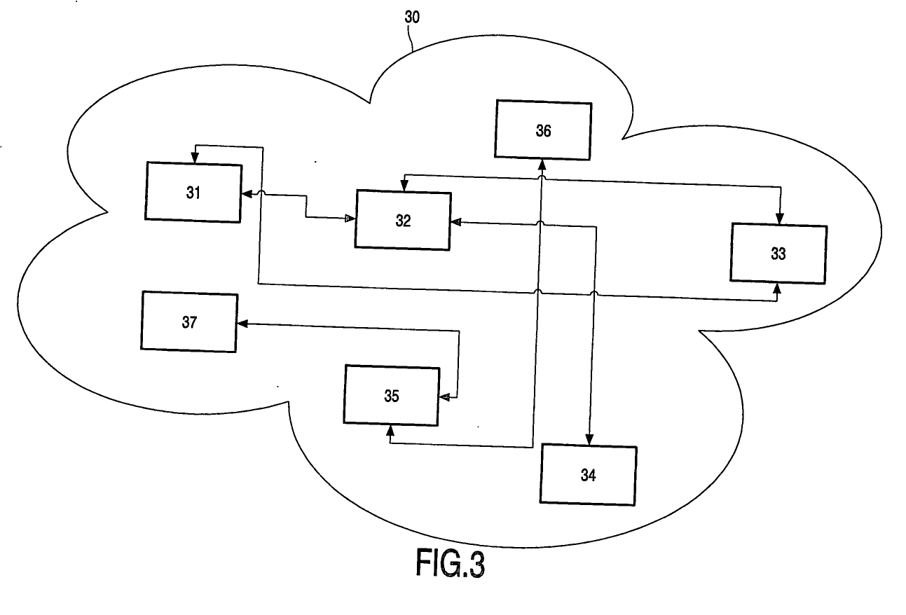

FIG. 3 shows a network of devices;

FIG. 4 shows a method of performing ownership transfer of a change in a peer to peer network, and

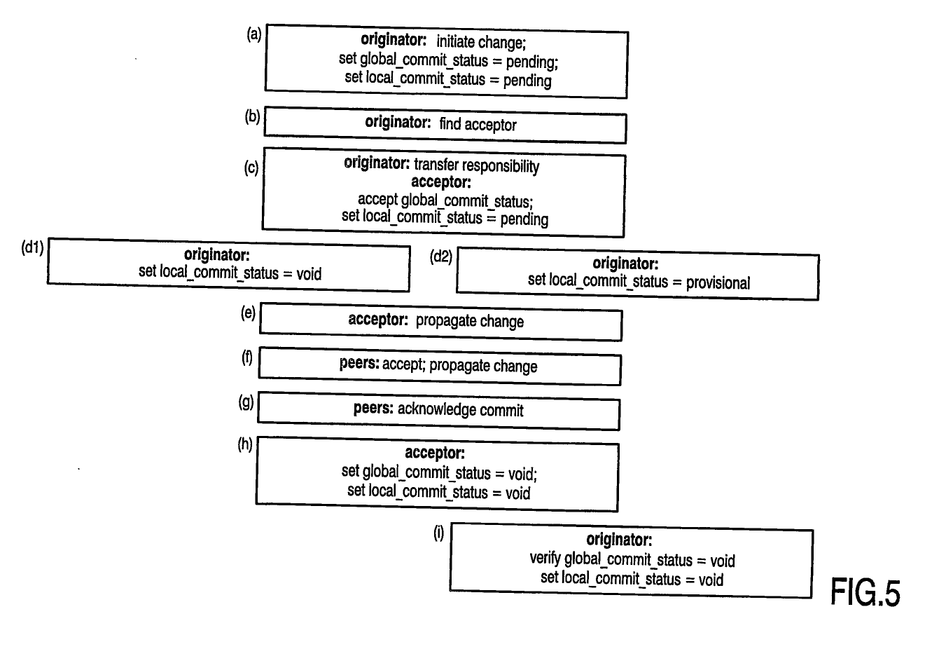

FIG. 5 shows commit status variable changes during transaction ownership transfer.

Throughout the description of the present invention, transaction is understood as the following:

In computer programming, a transaction usually means a sequence of information exchange and related work (such as a database or a file updating) that is treated as a unit for the purposes of satisfying a request and for ensuring database or file integrity. For a transaction to be completed, and database or file changes to be made permanent, the transaction has to be completed in its entirety. A typical business transaction could be a catalogue merchandise order phoned in by a customer and entered into a computer by a customer representative. The order transaction involves checking an inventory database, confirming that the item is available, placing the order, and confirming that the order has been placed and the expected time of shipment. If this is considered as a single transaction, then all of the steps must be completed before the transaction is successful and the database is actually changed to reflect the new order. If something happens before the transaction is successfully completed, any changes to the database must be kept track of so that they can be undone, e.g. rolled back.

FIG. 1 shows various ways for a peer in contact with the system transferring responsibility for an update to a peer in constant contact with the system.

In the figure, reference numeral (a) shows a peer in temporary contact with the system transferring responsibility (square) for an update (dark dot) to a peer in constant contact with the system.

Reference numeral (b) shows how the second peer accepts and the originator does a provisional commit (white dot).

Reference numeral (c) shows that the acceptor propagates the change to the other relevant peers.

Reference numeral (d) shows how the other peers acknowledge the change and that the change is committed (grey dots).

Reference numeral (e) shows that if the originator comes into contact with the system again it will check the status of the change.

Reference numeral (f) shows that the acceptor acknowledges the commit in the system.

FIG. 2 shows responsibility transfer with status change on a commit status variable.

This figure illustrates three deviations from FIG. 1:
1) The original acceptor propagates the responsibility to other peers (a reason could be 3)).
2) The originator assumes a real commit instead of a provisional.
3) The scope of the peers is more limited.

Reference numeral (a) shows a peer in temporary contact with the system transferring responsibility (square) for an update (dark dot) to a peer in constant contact with the system. Reference numeral (b) shows that the second peer accepts and that the originator assumes it can do a real commit (grey dot). Reference numeral (c) shows that the acceptor propagates the change (dark dot) and that the responsibility (square) to other relevant peers it is in contact with. Reference numeral (d) shows that both accepting peers accept responsibility and that the original acceptor does a real commit. Reference numeral (e) shows that the delegated acceptors propagate the update to further peers. Reference numeral (f) shows that the final update receiving peers acknowledge the commit in their system and that the delegated acceptors do the same. The latter also dissolves the update task.

With respect to state transition, three types of commits are mentioned, these are correspondingly reflected in a commit status variable having various states, i.e. a real commit state, a provisional commit state or an assumed commit state, however the assumed commit is not a separate state, i.e. it is the same state as a real commit, but reached through a different transition.

The assumed commit state is a real commit without confirmation. The initial state is uncommitted. The final state is committed. This is identical to the real commit state. The difference is that the real commit gets confirmation in-between. Note that the assumed commit state can dangerous, since it can lead to inconsistencies, i.e. if the update is not committed by other peers, even though the update was assumed to occur. For this reason the state of a provisional commit can be applied. So the difference between the assumed commit state and the provisional commit state is that in the latter case there is still a flag (or a similar indication) that indicates that the commit (state provisional) was not confirmed. If the confirmation arrives later, this flag can be removed, i.e. the commit state changes into (really) committed, i.e. the state of a real commit. So the state of a provisional commit can be seen as a ‘real’ commit for which the confirmation is expected to be late.

So, regarding commitment, four states exist for the commit status variable. By only looking at commitment there is no difference between 0 and 3, i.e. the database is with 3 in an updated state, but no updates are pending:
(0) no update pending=no state regarding commitment;
(1) uncommitted=update pending;
(2) provisional commit=update is committed to the database but unconfirmed; and
(3) real commit=update is confirmed (others commit) or assumed and committed.

In state (0) an update request is received, which brings it to state (1). The peer can now wait till it gets a confirmation (real commit=state (3)), assume confirmation (assumed commit=state (3)), or pretend for the moment that it has the confirmation, because it expects it will get it later (provisional commit=state (2)).

State (2) becomes state (3) if (finally) confirmation arrives. State (3) equals state (0), i.e. the updated state which corresponds to that no update is pending.

FIG. 3 shows a network of devices. Said network of devices is illustrated by means of reference numeral 30. As will be explained more detailed in the next figure, a first device, reference numeral 31, will do the attempt to find another, i.e. a second device, reference numeral 32, which will accept responsibility for committing a change. As a result, said second device will propagate the change to at least one more device, e.g. reference numerals 33 and 34 assuming said change is relevant for these devices. In the network further devices may be present, e.g. reference numerals 35, 36 and 37. The network is shown for illustrative purposes, any other dynamic or static topology or arrangement of peers or devices may also be applied in the present invention.

Any of said devices may be a car, a garage, a video cassette recorder (VCR), a personal digital assistant (PDA), a mobile phone, a climate system, a television, a lamp, a coffee machine, a radio, a DVD player, a CD player, an information panel, a web tablet, a smart remote, an answering machine or a personal computer. As an example, in principle, the lamp with access to the network may communicate change, e.g. a schedule change to a personal digital assistant (PDA), a web tablet, a smart remote, an answering machine and/or a personal computer, hereby it is assured that the user most likely will receive said schedule change.

The device alternatives as mentioned may be understood as corresponding peers in a peer-to-peer type of transient network similar to the type found on the Internet, that allows a group of computer users (with access to their corresponding peers or devices) with the same or similar networking program or protocol to connect with each other and directly access and/or update files, databases, etc to/from one another's hard drives, memories, etc. A peer-to-peer network is simply a network of peers, the Internet, Gnutella software, computers are all just examples of aspects of specific implementations.

Said state change can be applied in a protocol used for ownership transfer of a change, i.e. the protocol will comprise a commit status variable having various states, i.e. a real commit, and a provisional commit. If the originator of an update request tries to transfer the responsibility for commitment, it can also communicate which state it will be in after the responsibility is accepted by another. The originator can be uncommitted, committed or provisionally committed. The first case, i.e. the originator is uncommitted, is avoided according to the present invention since the acceptor needs to wait for commitment from the originator. The second case, i.e. the originator is committed, committed requires no further action from the acceptor towards the originator. The third case, i.e. the originator is provisionally committed, means that the acceptor needs to keep in mind that the originator may want or need confirmation later.

Note that any type of commit is a state change, i.e. the assumed commit is not a state it is a state transition.

The protocol may be applied in ownership transfer of changes among various devices (similar to peers), e.g. in a peer to peer network or in a similar network without a central server, it can in fact also be applied in a system with a central server but it makes less sense.

Said change can be any change to a database and/or to a file. Additionally or alternatively, said change may be a change to any information item, such as a variable, one or more parameters, one or more status flags, a string variable, etc.

In other words, said change may have the effect that text, numerical information, picture, video, sound and combinations thereof subsequently are updated in a file and/or a database.

The file and/or database may be stored individually or distributed in any device communicating on the peer to peer network or in a similar network.

In the following various practical applications of the invention are shown, the update is similar to said change.

### EXAMPLE 1

### Travelling Commits

Johan has forgotten certain drawings in his vault at home. He has no time to get them and asks Hendrik to get them for him. He changes his security settings of his home on his PDA device to allow Hendrik into his garage, his study and to open his vault. However, for security reasons he can not change these settings online. He transfers the responsibility for the update of his settings to his car and gives Hendrik his car keys. Hendrik uses the car of Johan to drive to Johan's home. As Hendrik reaches Johan's home, the car—as another device in the network—transfers the update of the security settings to the garage. The garage propagates the change to the rest of the devices of the home and Hendrik can get what he came for. As Hendrik leaves, security settings, i.e. a new change, are reverted to exclude Hendrik again. The garage—as yet another device in the network—informs the car of this update, i.e. the change. Back with Johan in the office the car updates the settings on Johan's PDA and Johan can trust that all is back to normal again. Hendrik hands him the drawings.

### EXAMPLE 2

### Fire and Forget Approach to Updating Code or Parameters on Many Peers or Devices

Pieter invites Fien to visit him for dinner. Unexpectedly, she says yes. He uses his mobile phone—as yet another device in the network—to prepare his ambient home for dinner with Fien. He has no time to go through all changes required but his answering machine (as another device, etc) accepts responsibility for propagating this information to all other relevant devices. As his PVR (as another device, etc) gets this information it prepares to record the live cricket game Pieter intended to watch. The climate system (as another device, etc) prepares to elevate the temperature from the usual 18 degrees to 19.5 degrees centigrade. The kitchen checks its stocks for a dinner for two with some class. It decides to order in some Cajun food. The messaging service reschedules the appointment with the 24 hours dentist on his corresponding device, e.g. his PDA. As Pieter gets home, he immediately gets informed that all but one of the changes due to dinner with Fien were successful so he can relax in anticipation of the arrival of Fien. There is one hitch, the rescheduling of his dentist appointment did not succeed and he will have to make a new appointment himself. The Cajun food arrives 15 minutes before Fien does so Pieter has time to put it in his own cooking ware.

### OTHER EXAMPLE

A group of persistent peers sort of emulate a central server towards multiple ad-hoc connected devices. At home Wubbo has several persistent peers that together handle his agenda Any device can always offload an item for the agenda to any of the persistent peers (i.e. devices) and rely on the change being committed.
Fast offload of updates before a pending shutdown. Carol's smart remote (as another device, etc) could not commit all pending changes before an imminent shutdown due to loss of power. It transfers responsibility to one of the responders (as other devices, etc) in the wall.
A task may require a sequence of devices each performing a subtask. The responsibility for the task travels with the task.

FIG. 4 shows a method of performing ownership transfer of a change in a peer to peer network. Said peer to peer network is similar to the network of devices from the foregoing figure, i.e. the ownership transfer of the change can be performed among devices in said networks.

Prior to the following steps, it is assumed that a change is originated at a device. This can be seen in the next figure, FIG. 5 which is generally also referred to in the present method description. In FIG. 5(a), the originator or the first device as claimed (corresponding to reference numeral 31 in FIG. 3)) attempts to find another, i.e. a second device, reference numeral 32, etc. At this stage only the first device knows about the change because it has not been communicated to any other devices. Two commit status variables are instantiated, which (to begin with) are both maintained by this originator. The first commit status variable has a local scope, signifying the status of the local database (value at this stage: ‘pending’). The second commit status variable has a global scope, signifying whether the change has been committed in all relevant peers (value at this stage: ‘pending’).

The second device was previously called the acceptor since it may accept responsibility for committing said change.

In step 100 (FIG. 1a, FIG. 2a, FIG. 5(b), the first device may attempt to find a second device which will accept responsibility for committing said change.

The attempt may prove not to be a success, i.e. all commit states (commit status variables) remain ‘pending’ and the first device will have to try again (to find another device to accept responsibility for committing said change) or it may prove to be a success, i.e. the next step.

In step 200 (FIG. 1b, FIG. 2b, FIG. 5(c), said first device may then transfer responsibility of committing the change to said second device. This means propagating the change to the acceptor (second device). Furthermore, this means that the responsibility for maintaining the global commit status variable is transferred to the second device. The location of this global variable will be on the second device.

In step 300, the originator, i.e. said first device, may set its local commit status variable to ‘provisional (FIG. 1b, FIG. 2b, FIG. 5(d2)), which signifies the device will act as if the global commit went through, but it will wait with setting the local commit status variable to ‘void’ until it gets confirmation that the global commit status variable is set to ‘void’ also. E.g. when said first device re-enters said network and check the status of the global commit status variable.

Normal procedure is to first check whether all parts of a database accept a certain change and then committing it (i.e. really going through with it). If a database is distributed, a device has to propagate the change to all relevant parts and they have to say that they accept the change. They do the latter by sending a message to that effect to the part of the database that is responsible for committing the change (is maintaining the global commit status variable). In a P2P setting this is normally the originator (1^{st} device), according to the present invention it is the acceptor (2^{nd} device). If the acceptor has confirmation from all peers (devices) that should apply the change that they will actually apply the change then the acceptor knows that the change is globally committed, so the global commit variable can be set to void.

The local commit status variable indicates whether the local database has applied the change or not.

The global commit status variable indicates whether all peers have applied the change or not.

Alternatively, in step 310, the local commits status variable may be set to ‘void’ which signifies a real commit (FIG. 2b, FIG. 5(d1)).

Said first device can wait or have to wait a certain amount of time before re-entering the network, and hereby—in the unconnected situation—resources may be freed to other tasks than communicating with the network, i.e. when said first device is a Personal Video Recorder it can dedicate its resources to record a movie.

In step 400, said second device may propagate said change to one or more devices for which said change is relevant (FIG. 1c, FIG. 2c, FIG. 5 (e, f, g, h)). This is the case when responsibility of committing the change is received and accepted on said second device.

The method may here be successfully finished, i.e. the ownership transfer of the change is here successfully transferred.

However, it is possible that said method may further comprise the following two steps.

In step 500, said first device may convert the local commit status variable of a provisional commit into a real commit. This is the case when said first device re-enters said network and receives a message indicating a successful commit from said second device (FIG. 5 (i)).

Again, said first device may wait a certain amount of time before entering the network. It may have the experience—from former situations spend unconnected—that it will take some time before the second device eventually will provide said successful commit message.

The originating device (said first device) may also convert the provisional status to ‘void’ after not being connected for a predetermined amount of time.

In step 600, said first device may receive a message indicating a non successful commit from said second device. That is the case when committing the change globally is not successfully performed by said second device, e.g. because the second device failed to reach all relevant peers or because one or more peers refused to commit the change (e.g. due to locking or conflicting updates). Said message may be received when said first device enters said network the next time.

The method may here be successfully finalized; however it is possible that said method additionally comprises the following step.

The values of the variables and the names of the parameters can be changed without departing from the concept of the invention. For example the value of the parameter “global commit status” can be “commit” in stead of “void” to indicate that the commit was a success.

In step 700, said first device may roll back said change. This is the case, for instance, when the local commit status (variable) is the provisional commit and step 600 occurs. The other peers (devices) did not commit so the provisional commit on the originator (first device) needs to be rolled back. If step 600 occurs and the originator has performed previously a real commit then no local commit status variable exists anymore for the change in question and the database is inconsistent. To remedy the situation the originator may initiate the same change again (i.e. retry) or initiate a new change to counter the first change and to lift the inconsistency.

A computer readable medium may be magnetic tape, optical disc, digital versatile disk (DVD), compact disc (CD record-able or CD write-able), mini-disc, hard disk, floppy disk, smart card, PCMCIA card, etc.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of performing ownership transfer of a change in a peer to peer network (30), said method comprising the steps of:
attempting (100), by means of a first device (31) to find a second device (32) which will accept responsibility for committing said change;
transferring (200), by means of said first device, responsibility of committing the change to said second device and propagating the change to said second device, wherein a global commit status variable is further transferred to said second device and where said global commit status variable is maintained on said second device;
setting (300), by means of said first device, a local commit status variable to “provisional” signifying that the device will act as if the global commit went through, wherein said first device will wait with setting the local commit status variable to ‘void’, signifying a real commit, until it gets confirmation that the global commit status variable is set to ‘void’ also, when said first device re-enters said network and checks the status of the global commit status variable; or
setting (310), by means of said first device, the local commit status variable to ‘void’ signifying a real commit; and
propagating (400), by means of said second device, said change to one or more devices (33, 34) for which said change is relevant, when responsibility of committing the change is received and accepted on said second device.

2. A method according to claim 1 further comprising the steps of:
converting (500), by means of said first device, the local commit status variable of a provisional commit into a real commit, when said first device re-enters said network and receives a message indicating a successful commit from said second device; and
receiving (600), a message on said first device indicating a non successful commit from said second device if committing the change is not successfully performed by said second device, when said first device re-enters said network.

3. A method according to claim 2 further comprising the step of:
rolling back (700), by means of said first device, said change when the local commit status variable is the provisional commit and the situation of the receiving step (600) occurs.

4. A method according to claim 1 characterized in that said change is at least one of a change to a database, a change to a file and a change to an information item.

5. A method according to claim 1 characterized in that any of said devices is one of a car, a garage, video cassette recorder (VCR), a personal digital assistant (PDA), a mobile phone, a climate system, a television, a lamp, a coffee machine, a radio, a DVD player, a CD player, an information panel, a web tablet, a smart remote, an answering machine, a personal computer, or any other electronic device.

6. A protocol for ownership transfer of a change characterized in that the protocol comprises a commit status variable having at least one of the states of a real commit and a provisional commit.

7. A device (31) for performing ownership transfer of a change, said device (31) comprising:
means for attempting to find a second device (32) which will accept responsibility for committing said change;
means for transferring responsibility of committing the change to said second device (32) and propagating the change to said second device (32), and means for transferring a global commit status variable to said second device (32);
means for setting a local commit status variable to “provisional” signifying that the device (31) will act as if the global commit went through, when said device (31) waits with setting the local commit status variable to ‘void’, signifying a real commit, until it gets confirmation that the global commit status variable is set to ‘void’ also, when said device (31) re-enters said network and checks the status of the global commit status variable; or
means for setting the local commit status variable to ‘void’ signifying a real commit; and
means for propagating said change to one or more devices (33, 34).

8. A device (31) according to claim 7, said device (31) further comprising:
means for converting the local commit status variable of an provisional commit into a real commit; and
means for receiving a message indicating a non successful commit.

9. A device (31) according to claim 8, said device (31) further comprising:
means for rolling back said change.

10. A computer system for performing the method according to claim 1.

11. A computer program product comprising program code means stored on a computer readable medium for performing the method of claim 1 when the computer program is run on a computer.
